(19) United States
(12) Patent Application Publication
(10) Pub. No.: US 2020/0217367 A1
(43) Pub. Date: Jul. 9, 2020

(54) MOTOR, BLOWING DEVICE, AND VACUUM CLEANER

(71) Applicant: NIDEC CORPORATION, Kyoto (JP)

(72) Inventors: Shota IKENO, Kyoto (JP); Akikazu FUJIWARA, Kyoto (JP)

(73) Assignee: NIDEC CORPORATION, Kyoto (JP)

(21) Appl. No.: 16/709,926

(22) Filed: Dec. 11, 2019

(30) Foreign Application Priority Data
Jan. 9, 2019 (JP) 2019-001908

(51) Int. Cl. F16C 33/78; F16C 19/00; F16J 15/3284

(52) U.S. Cl. CPC F16C 33/7803; A47L 5/22; F16J 15/3284; F16C 19/00

(57) ABSTRACT

A motor includes a rotor, a stator, a bearing, a motor housing, and a sealing member. The rotor includes a shaft. The stator faces the rotor in a radial direction. The bearing supports the rotor such that the rotor is able to rotate about the central axis. The motor housing surrounds at least a part of the stator. The sealing member includes a tubular part and a cover part. The tubular part extends in the axial direction and has an inner surface that faces an outer surface of the shaft in the radial direction with a gap interposed therebetween in the radial direction. The cover part extends inward from an inner surface of the tubular part in the radial direction. The cover part has a through-hole that penetrates therethrough in the axial direction on an inner side from an outer end of the shaft in the radial direction.

### CROSS REFERENCE TO RELATED APPLICATIONS

The present disclosure claims priority under 35 U.S.C. § 119 to Japanese Application No. 2019-001908 filed on Jan. 9, 2019 the entire content of which is incorporated herein by reference.

### BACKGROUND

### Field of the Disclosure

The present disclosure relates to a motor, a blowing device, and a vacuum cleaner.

### Background

A motor in the related art uses a rolling bearing capable of improving water-proofing properties and dust-proofing properties. A seal is attached between an inner ring and an outer ring of the rolling bearing. Further, an annular shielding plate that covers the seal so as to face at least one of the inner ring and the outer ring at an interval from the seal and outward from the seal in an axial direction is attached to the rolling bearing.

A bearing including a dust-proofing seal tends to be expensive. That is, if a rolling bearing in the related art is applied to a bearing that rotatably supports a rotor of a motor, there is a probability of an increase in costs of the motor. It is desired to improve dust-proofing properties of the bearing without leading to an increase in costs of the motor.

### SUMMARY

An illustrative motor according to the disclosure includes a rotor, a stator, a bearing, a motor housing, and a sealing member. The rotor has a shaft disposed along a central axis extending in an upward-downward direction. The stator faces the rotor in a radial direction. The bearing supports the rotor with respect to the stator such that the rotor is able to rotate about the central axis. The motor housing surrounds at least a part of the stator. The sealing member is disposed below the bearing and is secured to the motor housing. The sealing member has a tubular part and a cover part. The tubular part extends in the axial direction and has an inner surface in the radial direction that faces an outer surface of the shaft in the radial direction with a gap interposed therebetween in the radial direction. The cover part extends inward in the radial direction from the inner surface of the tubular part in the radial direction and has an upper surface facing a lower surface of the shaft with a gap interposed therebetween in the axial direction. The cover part has a through-hole penetrating therethrough in the axial direction on an inner side in the radial direction from an outer end of the shaft in the radial direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view of a motor according to an embodiment of the disclosure.

FIG. 2 is a vertical sectional view of the motor according to the embodiment of the disclosure.

FIG. 3 is a perspective view of a stator core according to the embodiment of the disclosure.

FIG. 4 is a perspective view of an upper housing according to the embodiment of the disclosure.

FIG. 5 is a perspective view of a lower housing according to the embodiment of the disclosure.

FIG. 6 is a perspective view of a sealing member according to the embodiment of the disclosure.

FIG. 7 is a vertical sectional view of the sealing member according to the embodiment of the disclosure.

FIG. 8 is a vertical sectional view illustrating a structure in the surroundings of the sealing member in the motor according to the embodiment of the disclosure.

FIG. 9 is an outline vertical sectional view for explaining a first modification example of the motor according to the embodiment of the disclosure.

FIG. 10 is an outline vertical sectional view for explaining a second modification example of the motor according to the embodiment of the disclosure.

FIG. 11 is an outline vertical sectional view for explaining a third modification example of the motor according to the embodiment of the disclosure.

FIG. 12 is an outline vertical sectional view for explaining a fourth modification example of the motor according to the embodiment of the disclosure.

FIG. 13 is an outline vertical sectional view for explaining a fifth modification example of the motor according to the embodiment of the disclosure.

FIG. 14 is an outline vertical sectional view for explaining a sixth modification example of the motor according to the embodiment of the disclosure.

FIG. 15 is an outline vertical sectional view for explaining a seventh modification example of the motor according to the embodiment of the disclosure.

FIG. 16 is an outline vertical sectional view for explaining an eighth modification example of the motor according to the embodiment of the disclosure.

FIG. 17 is a perspective view illustrating a vertical section of a blowing device according to an embodiment of the disclosure.

FIG. 18 is a perspective view illustrating a vacuum cleaner according to an embodiment of the disclosure.

### DESCRIPTION OF THE EMBODIMENTS

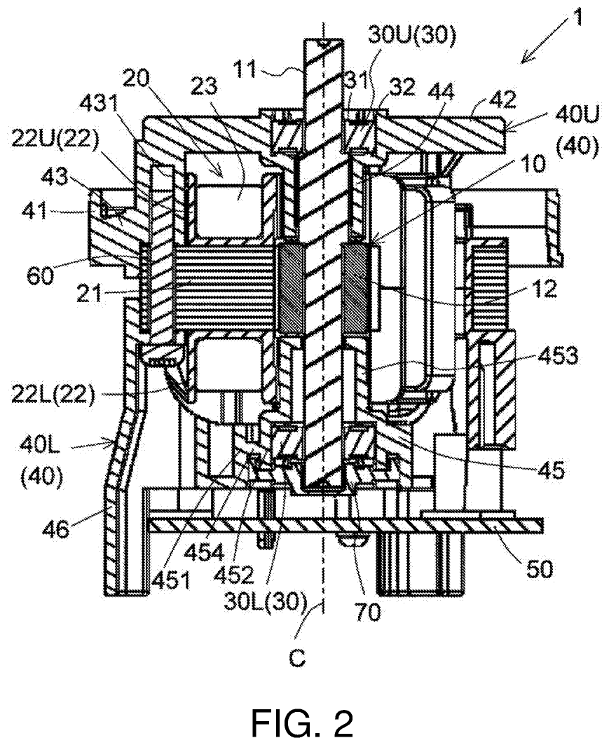

Hereinafter, illustrative embodiments of the disclosure will be described in detail with reference to drawings. In the specification, a direction that is parallel to a central axis C of a motor 1 will be referred to as an “axial direction”, a direction that perpendicularly intersects the central axis C will be referred to as a “radial direction”, and a direction along an arc around the central axis C at the center will be referred to as a “circumferential direction” in description of the motor 1 and a blowing device 100. Also, shapes and positional relationships of the respective components will be described on the assumption that the axial direction is an upward-downward direction and the upward-downward direction in FIG. 2 is an upward-downward direction in the motor 1 and the blowing device 100 in the specification. These directions are names that are used only for explanation and are not intended to limit actual positional relationships and directions.

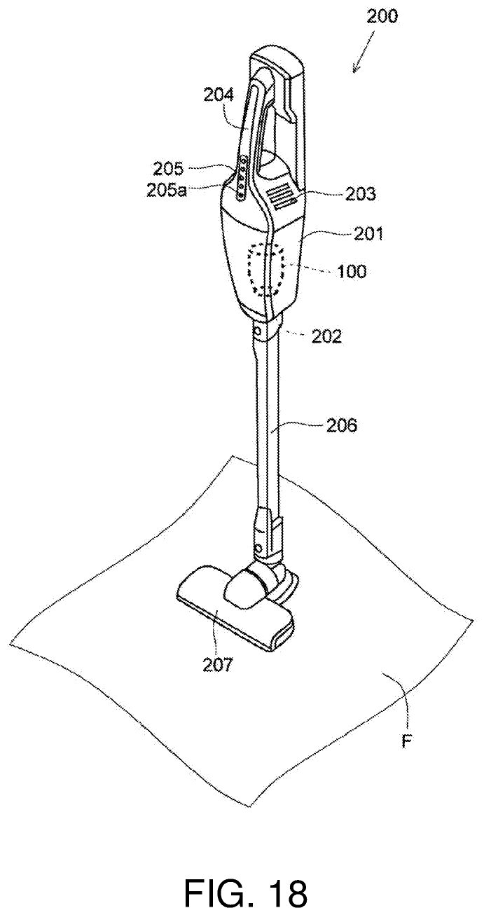

Also, shapes and positional relationships of the respective components will be described on the assumption that a direction toward a floor surface F (cleaned surface) in FIG. 18 corresponds to “downward” and a direction away from the floor surface F corresponds to “upward” for description of a vacuum cleaner 200 in the specification. In addition, these directions are names that are used only for explanation and are not intended to limit actual positional relationships and directions.

Also, “upstream” and “downstream” represent upstream and downstream in a distribution direction of an air flow 300 generated when an impeller 110 is caused to rotate, respectively, in the specification. In addition, a section that is parallel to the axial direction will be referred to as a “vertical section” in the specification. Also, “parallel” used in the specification includes substantially parallel. “Perpendicularly intersecting” used in the specification includes substantially perpendicularly intersecting.

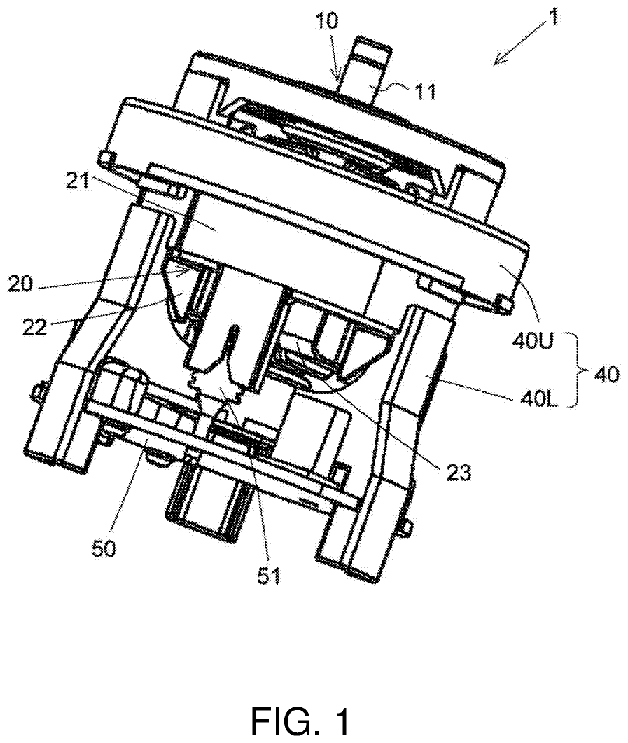

FIG. 1 is a perspective view of the motor 1 according to an embodiment of the disclosure. FIG. 2 is a vertical sectional view of the motor 1 according to the embodiment of the disclosure. As illustrated in FIGS. 1 and 2, the motor 1 includes a rotor 10, a stator 20, a bearing 30, a motor housing 40, and a sealing member 70. The motor 1 further includes a circuit substrate 50.

The rotor 10 includes a shaft 11. The rotor 10 further includes a magnet 12. The shaft 11 is disposed along the central axis C extending in an upward-downward direction. The shaft 11 is a columnar member made of metal, for example. The magnet 12 has a tubular shape extending in the axial direction. The magnet 12 is disposed outward from the shaft 11 in the radial direction and is secured to the shaft 11. N poles and S poles are alternately aligned in the circumferential direction on an outer surface of the magnet 12 in the radial direction.

The stator 20 is an armature that causes a magnetic flux in accordance with a drive current. The stator 20 faces the rotor 10 in the radial direction. Specifically, the stator 20 is disposed outward from the rotor 10 in the radial direction. The stator 20 includes a stator core 21, an insulator 22, and coils 23.

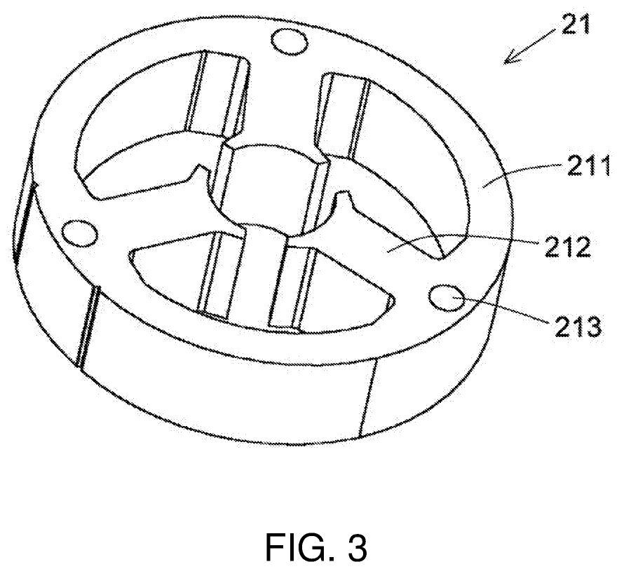

The stator core 21 is a laminated body in which electromagnetic steel plates are laminated in the axial direction. However, the stator core 21 may be a single member made through baking, casting, and the like of powder, for example. The stator core 21 may be formed by bonding a plurality of core pieces. FIG. 3 is a perspective view of the stator core 21 according to the embodiment of the disclosure.

As illustrated in FIG. 3, the stator core 21 has a core back 211 and a plurality of teeth 212. The core back 211 has an annular shape around the central axis C at the center. The teeth 212 project inward in the radial direction from the core back 211. The plurality of teeth 212 is aligned in the circumferential direction. In the embodiment, the number of teeth 212 is three. The three teeth 212 are aligned at equal intervals in the circumferential direction. The number of the teeth 212 may be a number other than three.

A plurality of stator core holes 213 is formed in the core back 211. The stator core holes 213 penetrate therethrough in the axial direction. The stator core holes 213 are disposed outward from the teeth 212 in the radial direction. The number of stator core holes 213 is the same as the number of the teeth 212. In the embodiment, the number of the stator core holes 213 is three. However, the number of the stator core holes 213 may be a number other than three.

The insulator 22 covers at least a part of the stator core 21. The insulator 22 is made of an insulating member such as a resin. In the embodiment, the insulator 22 has an upper insulator 22U and a lower insulator 22L. The upper insulator 22U covers the stator core 21 from the upper side. The lower insulator 22L covers the stator core 21 from the lower side. However, the insulator 22 may be configured to be integrated with the stator core 21 through insert molding.

Also, an outer end surface of the core back 211 in the radial direction and inner end surfaces of the teeth 212 in the radial direction are exposed without being covered with the insulator 22 in the embodiment.

Coils 23 are formed by winding conductive wires around the stator core 21 via the insulator 22. Specifically, the coils 23 are formed by winding conductive wires around the respective teeth 212 via the insulator 22. That is, the stator 20 includes a plurality of coils 23. The plurality of coils 23 is aligned at equal intervals in the circumferential direction. In the embodiment, the number of the coils 23 is three. However, the number of the coils 23 may be a number other than three.

The bearing 30 supports the rotor 10 with respect to the stator 20 such that the rotor 10 is able to rotate about the central axis C. In the embodiment, the bearing 30 has an upper bearing 30U and a lower bearing 30L. The upper bearing 30U is disposed such that at least a part thereof is located above the stator 20. The lower bearing 30L is disposed such that at least a part thereof is located below the stator 20. In the embodiment, the upper bearing 30U is disposed above the stator 20. The lower bearing 30L is disposed below the stator 20.

In the embodiment, the bearing 30 is a rolling bearing. Specifically, the upper bearing 30U and the lower bearing 30L are rolling bearings. Each of the upper bearing 30U and the lower bearing 30L has an inner ring 31 and an outer ring 32. The inner ring 31 is disposed outward from e the shaft 11 in the radial direction and is secured to the shaft 11. The outer ring 32 is disposed outward from the inner ring 31 in the radial direction and is secured to the motor housing 40. A rolling member such as a ball is disposed between the inner ring 31 and the outer ring 32 in the radial direction. The inner ring 31 is rotatably provided with respective to the outer ring 32. The number and the type of the bearings 30 may be changed from the configuration in the embodiment. The motor 1 may have a sleeve bearing or the like instead of the rolling bearing.

The motor housing 40 surrounds at least a part of the stator 20. The motor housing 40 is made of metal such as aluminum, for example. However, the motor housing 40 may be made of a material other than metal, such as a resin. In the embodiment, the motor housing 40 has an upper housing 40U and a lower housing 40L. The upper housing 40U covers the stator 20 from the upper side. The lower housing 40L covers the stator 20 from the lower side.

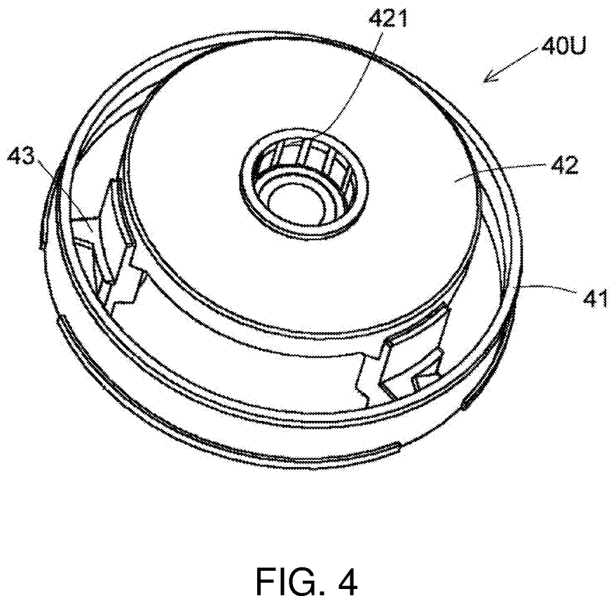

FIG. 4 is a perspective view of the upper housing 40U according to the embodiment of the disclosure. As illustrated in FIGS. 2 and 4, the upper housing 40U has a first housing part 41, a second housing part 42, and ribs 43. In the embodiment, a plurality of ribs 43 is provided, and specifically, the number of the ribs 43 is three. The three ribs 43 are aligned at equal intervals in the circumferential direction. However, the number of the ribs 43 may be a number other than three and may be one. Also, the first housing part 41, the second housing part 42, and the ribs 43 are a single member in the embodiment. In this manner, it is possible to improve strength as compared with a case in which a plurality of members is combined.

The first housing part 41 is disposed outward from the stator 20 in the radial direction. In the embodiment, the first housing part 41 has a tubular shape extending in the axial direction around the central axis C at the center. The first housing part 41 faces the stator 20 in the radial direction. The second housing part 42 is disposed inside the first housing part 41 in the radial direction. In the embodiment, the second housing part 42 has a circular plate shape. The second housing part 42 is disposed above the first housing part 41. The second housing part 42 faces the stator 20 in the axial direction. The ribs 43 connect the first housing part 41 to the second housing part 42. Specifically, the ribs 43 connect an inner surface of the first housing part 41 in the radial direction to an outer surface of the second housing part 42 in the radial direction. Rib recessed parts 431 that are recessed upward in the axial direction are formed in lower surfaces of the ribs 43.

An upper housing recessed part 421 that is recessed downward in the axial direction is formed at the center of the upper surface of the second housing part 42. The upper housing recessed part 421 has a circular shape around the central axis C at the center in a plan view from above in the axial direction. The upper bearing 30U is inserted into the upper housing recessed part 421. An inner surface of the upper housing recessed part 421 in the radial direction comes into contact with an outer surface in the radial direction of the outer ring 32 of the upper bearing 30U in the radial direction, and the upper bearing 30U is secured to the upper housing 40U.

Also, the upper housing 40U further includes an upper tubular part 44 as illustrated in FIG. 2 in the embodiment. The upper tubular part 44 has a tubular shape extending downward in the axial direction from a lower surface of the second housing part 42. The upper tubular part 44 is disposed inside the stator 20 in the radial direction. An upper surface opening of the upper tubular part 44 is connected with an opening formed in a bottom wall of the upper housing recessed part 421. The shaft 11 is inserted into the upper tubular part 44 and the upper housing recessed part 421 such that an upper part thereof projects upward from an upper surface of the upper housing 40U.

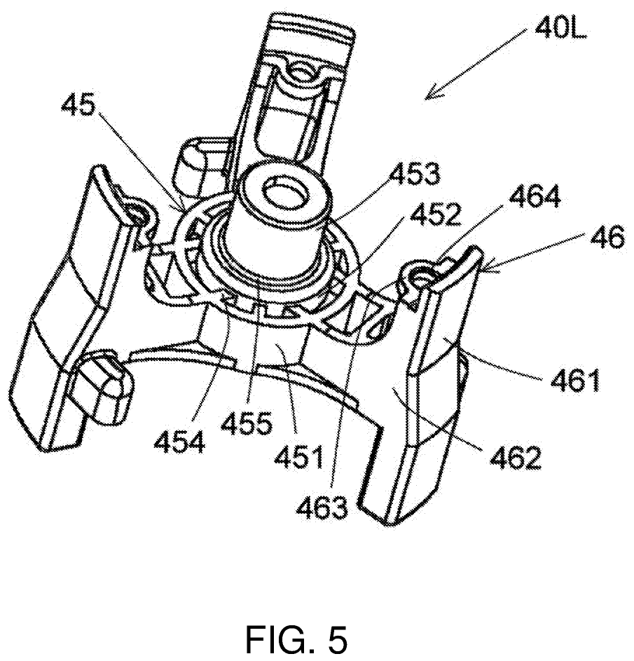

FIG. 5 is a perspective view of the lower housing 40L according to the embodiment of the disclosure. As illustrated in FIG. 5, the lower housing 40L has a lower housing main body 45 and a plurality of leg parts 46. In the embodiment, the number of the leg parts 46 is three. The three leg parts 46 are aligned at equal intervals in the circumferential direction. However, the number of the leg parts 46 may be a number other than three. Also, the lower housing main body 45 and the plurality of leg parts 46 are a single member in the embodiment. In this manner, it is possible to improve strength as compared with a case in which a plurality of members are combined.

As illustrated in FIGS. 2 and 5, the lower housing main body 45 has a lower annular part 451, a first lower tubular part 452, and a second lower tubular part 453. The lower annular part 451 has an annular shape around the central axis C at the center. The first lower tubular part 452 and the second lower tubular part 453 have tubular shapes extending in the axial direction around the central axis C at the center.

The first lower tubular part 452 is disposed inside the lower annular part 451 in the radial direction. The first lower tubular part 452 is connected to the lower annular part 451 with a first coupling part 454 disposed between the lower annular part 451 and the first lower tubular part 452 in the radial direction. The second lower tubular part 453 has a diameter that is smaller than that of the first lower tubular part 452 and is disposed above the first lower tubular part 452. The second lower tubular part 453 is connected to the first lower tubular part 452 with a second coupling part 455 extending inward in the radial direction from an upper end of the first lower tubular part 452. The second lower tubular part 453 is disposed inside the stator 20 in the radial direction. The shaft 11 is inserted into the first lower tubular part 452 and the second lower tubular part 453. The lower bearing 30L is inserted into the first lower tubular part 452. An inner surface of the first lower tubular part 452 in the radial direction comes into contact with the outer surface in the radial direction of the outer ring 32 of the lower bearing 30L in the radial direction, and the lower bearing 30L is secured to the lower housing 40L.

Each leg part 46 has a leg part outer wall 461, a pair of leg part side walls 462, and a leg part upper wall 463. The leg part outer wall 461 is disposed outward from the lower annular part 451 in the radial direction and extends in the axial direction. The pair of leg part side walls 462 face each other in the circumferential direction. One of the pair of leg part side walls 462 connects one end of the leg part outer wall 461 in the circumferential direction to the lower annular part 451. The other one of the pair of leg part side walls 462 connects the other end of the leg part outer wall 461 in the circumferential direction to the lower annular part 451. The leg part upper wall 463 extends inward in the radial direction from slightly below the upper end of the leg part outer wall 461. Both ends of the leg part upper wall 463 in the circumferential direction are connected to upper ends of the pair of leg part side walls 462. The leg part upper wall 463 includes a leg part hole 464 formed so as to penetrate therethrough in the axial direction.

The stator 20 is disposed between the upper housing 40U and the lower housing 40L in the axial direction, and the stator 20 is secured to the upper housing 40U and the lower housing 40L with securing members 60. In the embodiment, the securing members 60 are screws. The securing members 60 are inserted into the leg part hole 464, the stator core hole 213, and the rib recessed part 431 from the side below the lower housing 40L. The securing members 60 may be rivets instead of the screws. In the embodiment, the number of the securing members 60 is three. However, the number of the securing members 60 may be a number other than three.

The circuit substrate 50 is disposed below the lower bearing 30L. The circuit substrate 50 is secured to the lower housing 40L. Specifically, the circuit substrate 50 is secured to the plurality of leg parts 46. On the circuit substrate 50, circuits for driving the motor 1, such as a power supply circuit and a control circuit, for example, are formed. As illustrated in FIG. 1, electrical connection parts 51 that are electrically connected to the coils 23 are disposed on the circuit substrate 50. The electrical connection parts 51 may be tab terminals, for example. In the embodiment, the number of the electrical connection parts 51 is three, and the three electrical connection parts 51 are disposed at equal intervals in the circumferential direction. The number of electrical connection parts 51 may be a number other than three.

The sealing member 70 is disposed below the bearing 30. Specifically, the sealing member 70 is disposed below the lower bearing 30L. The sealing member 70 is secured to the motor housing 40. The sealing member 70 is made of a resin or rubber, for example. The sealing member 70 is provided in order to prevent foreign matter such as dust from entering the lower bearing 30L, for example. Details of the sealing member 70 will be described later.

If power is supplied to the respective coils 23 from the power source, magnetic fluxes are generated in the respective teeth 212. A torque in the circumferential direction is generated by actions of the magnetic fluxes generated in the respective teeth 212 and a magnetic field generated by the magnet 12. As a result, the rotor 10 rotates with respect to the stator 20. The rotor 10 rotates about the central axis C.

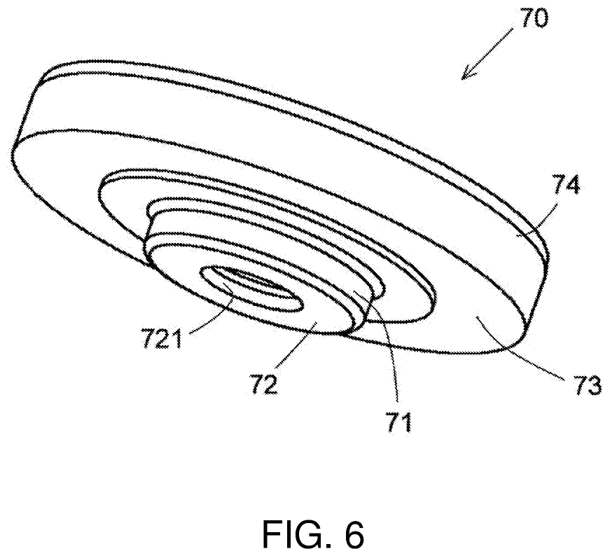

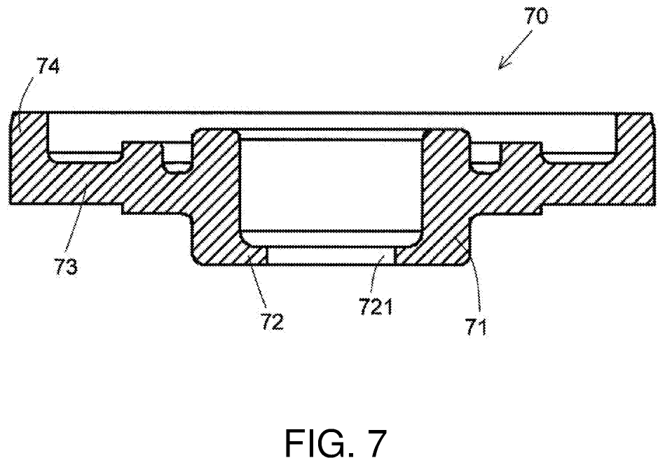

FIG. 6 is a perspective view of the sealing member 70 according to the embodiment of the disclosure. FIG. 7 is a vertical sectional view of the sealing member 70 according to the embodiment of the disclosure. As illustrated in FIGS. 6 and 7, the sealing member 70 has a tubular part 71 and a cover part 72. The sealing member 70 further has a base part 73. The sealing member 70 further has a connection part 74.

The tubular part 71 extends in the axial direction. The tubular part 71 has a tubular shape around the central axis C at the center. The cover part 72 extends inward in the radial direction from the inner surface of the tubular part 71 in the radial direction. The cover part 72 has a through-hole 721 penetrating therethrough in the axial direction. That is, the cover part 72 has an annular shape around the central axis C at the center. Specifically, the cover part 72 has an annular shape. In the embodiment, the cover part 72 extends inward in the radial direction from a lower end of the tubular part 71. There is no step difference between the lower surface of the tubular part 71 and the lower surface of the cover part 72, and the lower surface at a portion at which the tubular part 71 is connected with the cover part 72 is flat.

The base part 73 spreads outward in the radial direction from the outer surface of the tubular part 71 in the radial direction. The base part 73 has a plate shape and also has a circular shape in a plan view in the axial direction. In the embodiment, the base part 73 extends outward in the radial direction at a position below the upper end of the tubular part 71 and above the lower end thereof. The thickness of the base part 73 in the axial direction is not constant in the radial direction. However, the thickness of the base part 73 in the axial direction may be constant in the radial direction. By the base part 73 being provided, it is possible to secure the sealing member 70 to the motor housing 40 without setting the thickness of the tubular part 71 in the radial direction to be unnecessarily thick. With this configuration, it is possible to manufacture the sealing member 70 at low cost.

The connection part 74 extends in the axial direction in an outer surface of the base part 73 in the radial direction. An inner surface of the connection part 74 in the radial direction is connected with an outer surface of the base part 73 in the radial direction. In the embodiment, the connection part 74 has a tubular shape. There is no step difference between a lower surface of the connection part 74 and a lower surface of the base part 73, and a lower surface at a portion at which the connection part 74 is connected with the base part 73 is flat. An upper end of the connection part 74 is disposed above an upper end of the base part 73 in the axial direction.

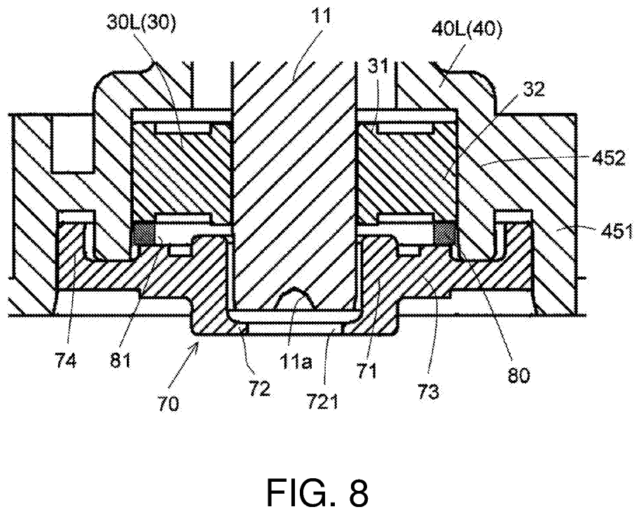

FIG. 8 is a vertical sectional view illustrating a structure in the surroundings of the sealing member 70 in the motor 1 according to the embodiment of the disclosure. As illustrated in FIG. 8, the shaft 11 has a lower part projecting downward in the axial direction from the lower end of the lower bearing 30L. In the embodiment, the lower part of the shaft 11 has a columnar shape.

As illustrated in FIG. 8, the tubular part 71 has an inner surface in the radial direction that faces the outer surface of the shaft 11 in the radial direction with a gap interposed therebetween in the radial direction. The cover part 72 has an upper surface that faces the lower surface of the shaft 11 with a gap interposed therebetween in the axial direction. The cover part 72 has a through-hole 721 penetrating therethrough in the axial direction on an inner side in the radial direction from the outer end of the shaft 11 in the radial direction. That is, the through-hole 721 overlaps with the lower surface of the shaft 11 in the axial direction.

With this configuration, the sealing member 70 does not come into contact with the shaft 11. That is, the sealing member 70 does not prevent the rotation of the shaft 11 about the central axis C. Since the sealing member 70 that has the tubular part 71 and the cover part 72, which face the shaft 11 with a gap interposed therebetween, is disposed below the lower bearing 30L, it is possible to curb entrance of dust from the side below the lower bearing 30L toward the bearing. With this configuration, it is possible to improve dust-proofing properties of the lower bearing 30L without using an expensive bearing provided with a dust-proofing sealing. With this configuration, since the cover part 72 has the through-hole 721, it is possible to support the shaft 11 with a jig from the side below the motor 1 even after the sealing member 70 is attached to the motor housing 40. Therefore, it is possible to improve operability of an operation for attaching a member such as an impeller 110 above the shaft 11, for example.

The connection part 74 is connected to the motor housing 40. Specifically, the outer surface of the connection part 74 in the radial direction and the inner surface of the lower annular part 451 in the radial direction are connected to each other in the radial direction. The outer surface of the connection part 74 in the radial direction may come into contact with the inner surface of the lower annular part 451 in the radial direction by the sealing member 70 being pressure-fitted or slightly pressure-fitted into the lower housing 40L, for example. That is, the outer surface of the connection part 74 in the radial direction and the inner surface of the lower annular part 451 in the radial direction may be connected directly to each other. In this manner, the sealing member 70 may be secured to the lower housing 40L.

However, the outer surface of the connection part 74 in the radial direction may be connected to the inner surface of the lower annular part 451 in the radial direction with an intermediate member such as an adhesive interposed between the sealing member 70 and the lower annular part 451 in the radial direction. That is, the outer surface of the connection part 74 in the radial direction and the inner surface of the lower annular part 451 in the radial direction may be connected indirectly to each other. In this manner, the sealing member 70 may be secured to the lower housing 40L. Also, the motor 1 may have a portion at which the outer surface of the connection part 74 in the radial direction and the inner surface of the lower annular part 451 in the radial direction are connected directly to each other and a portion at which the outer surface of the connection part 74 in the radial direction and the inner surface of the lower annular part 451 in the radial direction are connected indirectly to each other.

By the sealing member 70 including the connection part 74, it is possible to increase a contact area between the sealing member 70 and the lower housing 40L. Therefore, it is possible to improve securing strength of the sealing member 70 with respect to the lower housing 40L. Also, it is possible to reduce invasion routes of dust and to improve dust-proofing properties of the lower bearing 30L by the connection part 74 and the lower housing 40L being connected to each other.

In addition, it is not necessary for the sealing member 70 to include the connection part 74. In this case, the outer surface of the base part 73 in the radial direction may be connected directly or indirectly to the inner surface of the lower annular part 451 in the radial direction, for example. In addition, the outer surface of the tubular part 71 in the radial direction may be connected and secured to the motor housing 40 even in a case in which the sealing member 70 has the connection part 74. In this case, the outer surface of the tubular part 71 in the radial direction may be connected directly or indirectly to the inner surface of the first lower tubular part 452 in the radial direction, for example.

In addition, the lower surface of the first lower tubular part 452 comes into contact with the upper surface of the base part 73 in the axial direction or faces the upper surface of the base part 73 with a gap interposed therebetween in the embodiment. Also, the inner surface of the connection part 74 in the radial direction and the outer surface of the first lower tubular part 452 in the radial direction face each other with a gap interposed therebetween in the radial direction. Therefore, it is possible to curb invasion of dust toward the lower bearing 30L.

As illustrated in FIG. 8, the motor 1 further has an elastic member 80. The elastic member 80 is disposed between the sealing member 70 and the lower bearing 30L in the axial direction. As described above, the lower bearing 30L is a rolling bearing. That is, the elastic member 80 is disposed between the sealing member 70 and the rolling bearing 30L in the axial direction. The elastic member 80 may be a wave washer or the like that has an opening 81 penetrating therethrough in the axial direction, for example.

A lower surface of at least a part of the elastic member 80 comes into contact with the upper surface of the sealing member 70. Specifically, the lower surface of at least a part of the elastic member 80 comes into contact with the upper surface of the base part 73. An upper surface of at least a part of the elastic member 80 comes into contact with the lower surface of the outer ring 32 of the lower bearing 30L. That is, the upper surface of the sealing member 70 supports the lower surface of the outer ring 32 of the rolling bearing 30L via the elastic member 80.

With this configuration, it is possible to apply a preload in the axial direction to the outer ring 32 of the lower bearing 30L with the elastic member 80 and to curb generation of vibration and noise during driving of the motor 1. In addition, the motor 1 may not include the elastic member 80.

In the embodiment, a recessed part 11 a that is recessed upward in the axial direction is formed in the lower surface of the shaft 11. The recessed part 11a has a circular shape, for example, in a plan view in the axial direction. However, the shape of the recessed part 11 a may be another shape. With this configuration, it is possible to position a receiving jig or the like that receives the shaft 11 with the recessed part 11 a at the time of assembling of the motor 1. That is, with this configuration, it is possible to improve a degree of freedom in handling the shaft 11 or the motor 1 that includes the shaft 11 in a plant facility.

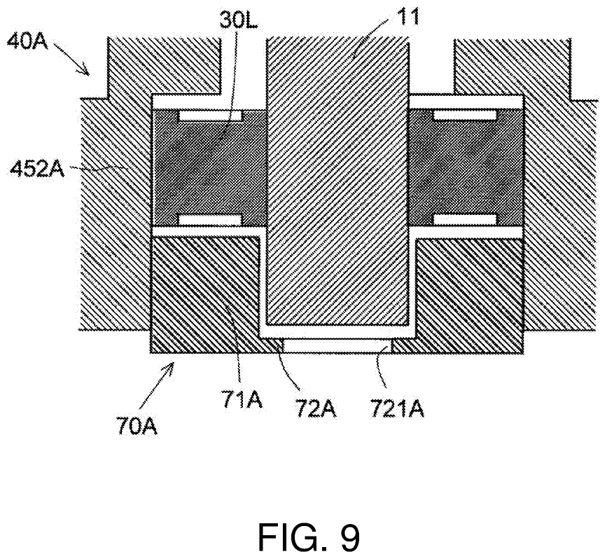

FIG. 9 is an outline vertical sectional view for explaining a first modification example of the motor 1 according to the embodiment of the disclosure. FIG. 9 is a vertical sectional view illustrating a structure in the surroundings of a sealing member 70A. Similarly to the aforementioned embodiment, a motor housing 40A has a first lower tubular part 452A at which the lower bearing 30L is disposed.

The sealing member 70A has a tubular part 71A and a cover part 72A. The tubular part 71A extends in the axial direction and has an inner surface in the radial direction that faces the outer surface of the shaft 11 in the radial direction with a gap interposed therebetween in the radial direction. The cover part 72A extends inward in the radial direction from an inner surface of the tubular part 71A in the radial direction at a lower end of the tubular part 71A. An upper surface of the cover part 72A faces the lower surface 11 with a gap interposed therebetween in the axial direction. The cover part 72A has a through-hole 721A penetrating therethrough in the axial direction on an inner side in the radial direction from the outer end of the shaft 11 in the radial direction.

In the embodiment, the sealing member 70A does not have portions corresponding to the base part 73 and the connection part 74 described above. Since the sealing member 70A that has the tubular part 71A and the cover part 72A, which face the shaft 11 with a gap interposed therebetween, is disposed below the lower bearing 30L, it is possible to curb entrance of dust from the side below the lower bearing 30L toward the bearing even with this configuration.

In the modification example, an outer surface of the tubular part 71A in the radial direction is connected and secured to the motor housing 40A. Specifically, the outer surface of the tubular part 71A in the radial direction is connected and secured to the inner surface of the first lower tubular part 452A in the radial direction. The outer surface of the tubular part 71A in the radial direction may come into contact with the inner surface of the first lower tubular part 452A in the radial direction by the sealing member 70A being pressure-fitted or slightly pressure-fitted into the first lower tubular part 452A, for example. That is, the outer surface of the tubular part 71A in the radial direction may be connected and secured directly to the inner surface of the first lower tubular part 452A in the radial direction.

However, the outer surface of the tubular part 71A in the radial direction may be connected to the inner surface of the first lower tubular part 452A in the radial direction with an intermediate member such as an adhesive interposed between the sealing member 70A and the first lower tubular part 452A in the radial direction. That is, the outer surface of the tubular part 71A in the radial direction may be connected and secured indirectly to the inner surface of the first lower tubular part 452A in the radial direction.

According to the modification example, it is possible to cause the outer surface of the tubular part 71A in the radial direction to be connected to the inner surface of the motor housing 40A spreading in the circumferential direction and the axial direction within a wide range and to appropriately keep the gap between the sealing member 70A and the shaft 11 in the radial direction.

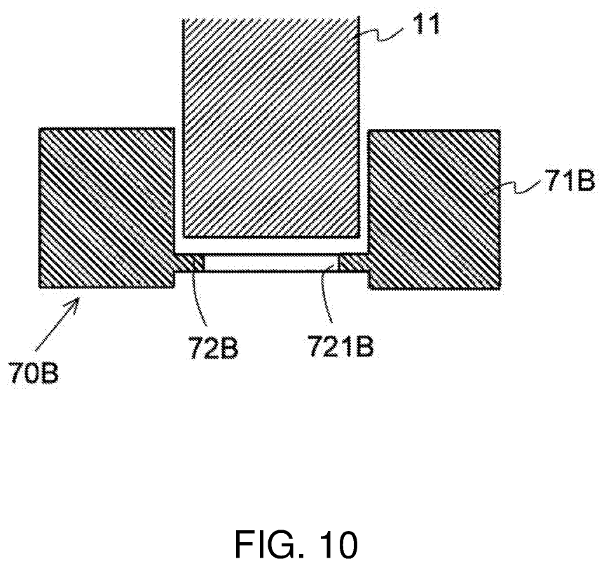

FIG. 10 is an outline vertical sectional view for explaining a second modification example of the motor 1 according to the embodiment of the disclosure. FIG. 10 is a vertical sectional view illustrating a relationship between a sealing member 70B and the shaft 11. The sealing member 70B has a tubular part 71B and a cover part 72B.

The tubular part 71B extends in the axial direction and has an inner surface in the radial direction that face the outer surface of the shaft 11 in the radial direction with a gap interposed therebetween in the radial direction. The cover part 72B extends inward in the radial direction from an inner surface of the tubular part 71B in the radial direction. In the modification example, the cover part 72B extends in the radial direction from the inner surface in the radial direction at a position below the upper end of the tubular part 71B and above the lower end thereof. Therefore, there is a step difference between a lower surface of the tubular part 71B and a lower surface of the cover part 72B unlike the first modification example. An upper surface of the cover part 72B faces the lower surface of the shaft 11 with a gap interposed therebetween in the axial direction. The cover part 72B has a through-hole 721B penetrating therethrough in the axial direction on an inner side in the radial direction from the outer end of the shaft 11 in the radial direction.

Since the sealing member 70B that has the tubular part 71B and the cover part 72B, which face the shaft 11 with a gap interposed therebetween, is disposed below the lower bearing 30L, it is possible to curb entrance of dust from the side below the lower bearing 30L toward the bearing even in the modification example.

In addition, the sealing member 70B does not have portions corresponding to the base part 73 and the connection part 74 described above in the modification example similarly to the first modification example. However, the sealing member 70B may have at least a portion corresponding to the base part 73 out of the base part 73 and the connection part 74 described above.

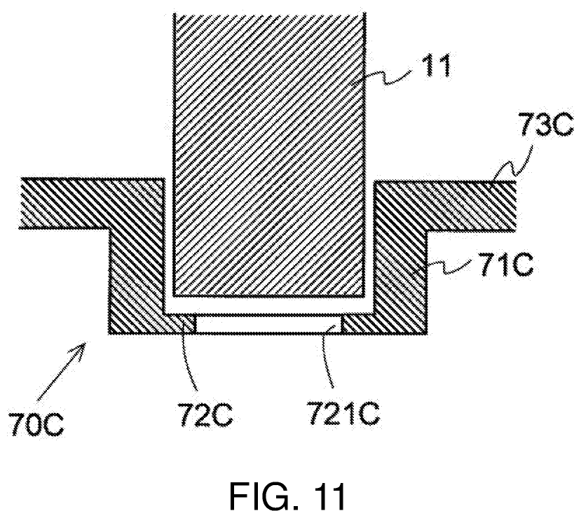

FIG. 11 is an outline vertical sectional view for explaining a third modification example of the motor 1 according to the embodiment of the disclosure. FIG. 11 is a vertical sectional view illustrating a relationship between a sealing member 70C and the shaft 11. The sealing member 70C has a tubular part 71C, a cover part 72C, and a base part 73C.

The tubular part 71C extends in the axial direction and has an inner surface in the radial direction that faces the outer surface of the shaft 11 in the radial direction with a gap interposed therebetween in the radial direction. The cover part 72C extends inward in the radial direction from an inner surface of the tubular part 71C in the radial direction at a lower end of the tubular part 71C. However, the cover part 72C may extend in the radial direction from the inner surface in the radial direction at a position below the upper end of the tubular part 71C and above the lower end thereof. An upper surface of the cover part 72C faces the lower surface of the shaft 11 with a gap interposed therebetween in the axial direction. The cover part 72C has a through-hole 721C penetrating therethrough in the axial direction on an inner side in the radial direction from the outer end of the shaft 11 in the radial direction.

The base part 73C spreads outward in the radial direction from the upper end of the tubular part 71C. There is no step difference between the upper surface of the tubular part 71C and the upper surface of the base part 73C, and an upper surface at a part at which the tubular part 71C is connected with the base part 73C is flat. Meanwhile, there is a step difference between a lower surface of the tubular part 71C and a lower surface of the base part 73C. Also, a portion that is similar to the aforementioned connection part 74 may or may not be disposed outward from the base part 73C in the radial direction.

Since the sealing member 70C that has the tubular part 71C and the cover part 72C, which face the shaft 11 with a gap interposed therebetween, is disposed below the lower bearing 30L, it is possible to curb entrance of dust from the side below the lower bearing 30L toward the bearing even in the modification example. Since the base part 73C is provided, it is possible to secure the sealing member 70C to the motor housing 40 without setting the thickness of the tubular part 71C in the radial direction to be unnecessarily thick.

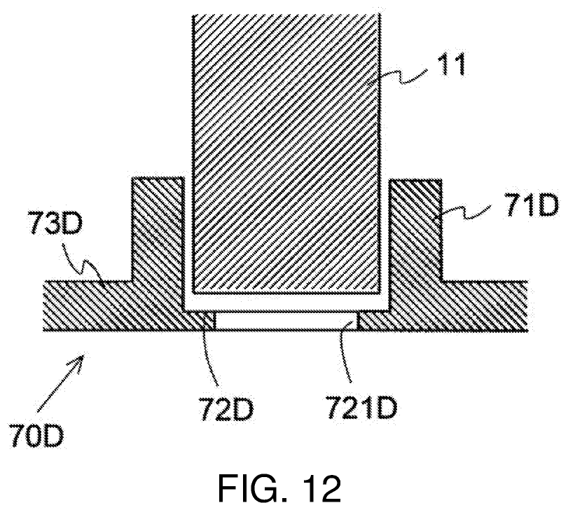

FIG. 12 is an outline vertical sectional view for explaining a fourth modification example of the motor 1 according to the embodiment of the disclosure. FIG. 12 is a vertical sectional view illustrating a relationship between a sealing member 70D and the shaft 11. The sealing member 70D has a tubular part 71D, a cover part 72D, and a base part 73D.

The tubular part 71D extends in the axial direction and has an inner surface in the radial direction that faces the outer surface of the shaft 11 in the radial direction with a gap interposed therebetween in the radial direction. The cover part 72D extends inward in the radial direction from an inner surface of the tubular part 71D in the radial direction at a lower end of the tubular part 71D. However, the cover part 72D may extend in the radial direction from the inner surface in the radial direction at a position below the upper end of the tubular part 71D and above the lower end thereof. An upper surface of the cover part 72D faces the lower surface of the shaft 11 with a gap interposed therebetween in the axial direction. The cover part 72D has a through-hole 721D penetrating therethrough in the axial direction on an inner side in the radial direction from the outer end of the shaft 11 in the radial direction.

The base part 73D spreads outward in the radial direction from a lower end of the tubular part 71D. There is no step difference between a lower surface of the tubular part 71D and a lower surface of the base part 73D, and a lower surface at a portion at which the tubular part 71D is connected with the base part 73D is flat. Meanwhile, there is a step difference between an upper surface of the tubular part 71D and an upper surface of the base part 73D. In addition, a portion that is similar to the aforementioned connection part 74 may or may not be disposed outward from the base part 73D in the radial direction.

Since the sealing member 70D that has the tubular part 71D and the cover part 72D, which face the shaft 11 with an interposed therebetween, is disposed below the lower bearing 30L, it is possible to curb entrance of dust from the side below the lower bearing 30L toward the bearing even in the modification example. It is possible to cause dust directed from the outside toward the outer surface of the shaft 11 in the radial direction to collide against the tubular part 71D, it is possible to make it difficult for the dust to reach the lower bearing 30L. Since the base part 73D is provided, it is possible to secure the sealing member 70D to the motor housing 40 without setting the thickness of the tubular part 71D in the radial direction to be unnecessarily thick.

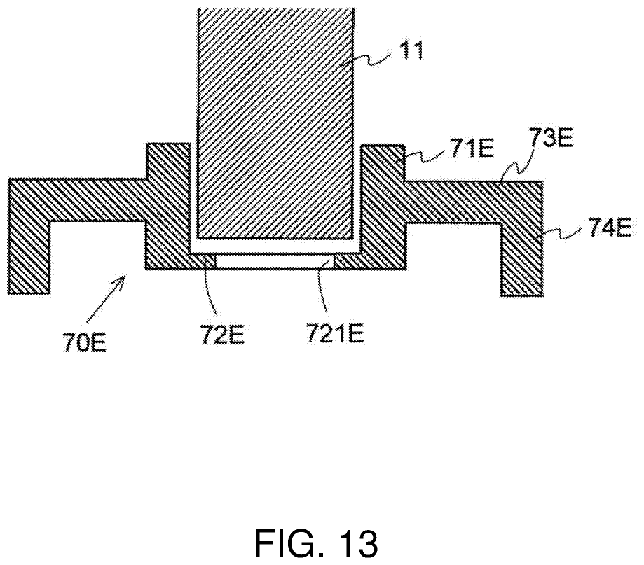

FIG. 13 is an outline vertical sectional view for explaining a fifth modification example of the motor 1 according to the embodiment of the disclosure. FIG. 13 is a vertical sectional view illustrating a relationship between a sealing member 70E and the shaft 11. The sealing member 70E has a tubular part 71E, a cover part 72E, a base part 73E, and a connection part 74E.

The tubular part 71E extends in the axial direction and has an inner surface in the radial direction that faces the outer surface of the shaft 11 in the radial direction with a gap interposed therebetween in the radial direction. The cover part 72E extends inward in the radial direction from an inner surface of the tubular part 71E in the radial direction at a lower end of the tubular part 71E. However, the cover part 72E may extend in the radial direction from the inner surface in the radial direction at a position below the upper end of the tubular part 71E and above the lower end thereof. An upper surface of the cover part 72E faces the lower surface of the shaft 11 with a gap interposed therebetween in the axial direction. The cover part 72E has a through-hole 721E penetrating therethrough in the axial direction on an inner side in the radial direction from the outer end of the shaft 11 in the radial direction.

The base part 73E spreads outward in the radial direction from a position below an upper end of the tubular part 71E and above a lower end thereof. However, the base part 73E may spread outward in the radial direction at the upper end or the lower end of the tubular part 71E. The connection part 74E extends in the axial direction in an outer surface of the base part 73E in the radial direction. There is no step difference between an upper surface of the connection part 74E and an upper surface of the base part 73E, and an upper surface at a portion at which the connection part 74E is connected with the base part 73E is flat. The lower end of the connection part 74E is disposed below the lower end of the base part 73E in the axial direction. The connection part 74E is connected to the motor housing 40.

Since the sealing member 70E that has the tubular part 71E and the cover part 72E, which face the shaft 11 with a gap interposed therebetween, is disposed below the lower bearing 30L, it is possible to curb entrance of dust from the side below the lower bearing 30L toward the bearing even in the modification example. Since the base part 73E is provided, it is possible to secure the sealing member 70E to the motor housing 40 without setting the thickness of the tubular part 71E in the radial direction to be unnecessarily thick. Since the connection part 74E is provided, it is possible to increase a connection area between the sealing member 70E and the motor housing 40 and to improve securing strength of the sealing member 70E with respect to the motor housing 40. Also, it is possible to reduce invasion routes of dust and to improve dust-proofing properties of the lower bearing 30L by the connection part 74E and the motor housing 40 being connected to each other.

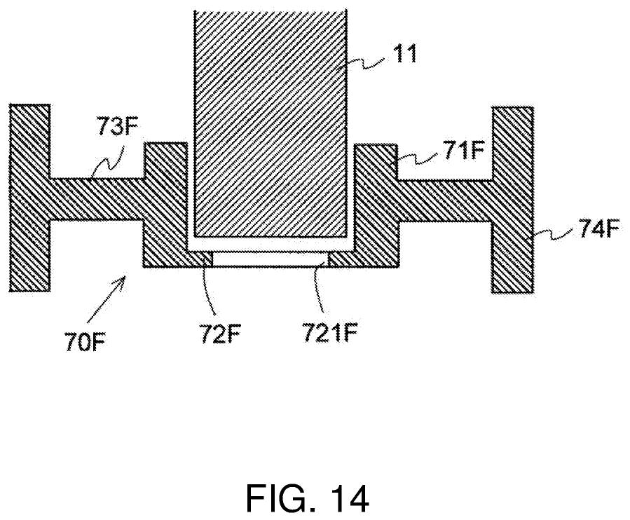

FIG. 14 is an outline vertical sectional view for explaining a sixth modification example of the motor 1 according to the embodiment of the disclosure. FIG. 14 is a vertical sectional view illustrating a relationship between a sealing member 70F and the shaft 11. The sealing member 70F has a tubular part 71F, a cover part 72F, a base part 73F, and a connection part 74F.

The tubular part 71F extends in the axial direction and has an inner surface in the radial direction that faces the outer surface of the shaft 11 in the radial direction with a gap interposed therebetween in the radial direction. The cover part 72F extends inward in the radial direction from an inner surface of the tubular part 71F in the radial direction at a lower end of the tubular part 71F. However, the cover part 72F may extend in the radial direction from the inner surface in the radial direction at a position below the upper end of the tubular part 71F and above the lower end thereof. An upper surface of the cover part 72F faces the lower surface of the shaft 11 with a gap interposed therebetween in the axial direction. The cover part 72F has a through-hole 721F penetrating therethrough in the axial direction on an inner side in the radial direction from the outer end of the shaft 11 in the radial direction.

The base part 73F spreads outward in the radial direction from a position below the upper end of the tubular part 71F and above the lower end thereof. However, the base part 73F may spread outward in the radial direction from the upper end or the lower end of the tubular part 71F. The connection part 74F extends in the axial direction in an outer surface of the base part 73F in the radial direction. The upper end of the connection part 74F is disposed above an upper end of the base part 73F in the axial direction. The lower end of the connection part 74F is disposed below a lower end of the base part 73F in the axial direction. The connection part 74F is connected to the motor housing 40.

Since the sealing member 70F that has the tubular part 71F and the cover part 72F, which face the shaft 11 with a gap therebetween, is disposed below the lower bearing 30L, it is possible to curb entrance of dust from the side below the lower bearing 30L toward the bearing even in the modification example. Since the base part 73F is provided, it is possible to secure the sealing member 70F to the motor housing 40 without setting the thickness of the tubular part 71F in the radial direction to be unnecessarily thick. Since the connection part 74F is provided, it is possible to increase a connection area between the sealing member 70F and the motor housing 40 and to improve securing strength of the sealing member 70F with respect to the motor housing 40. Also, it is possible to reduce invasion routes of dust and to improve dust-proofing properties of the lower bearing 30L by the connection part 74F and the motor housing 40 being connected to each other.

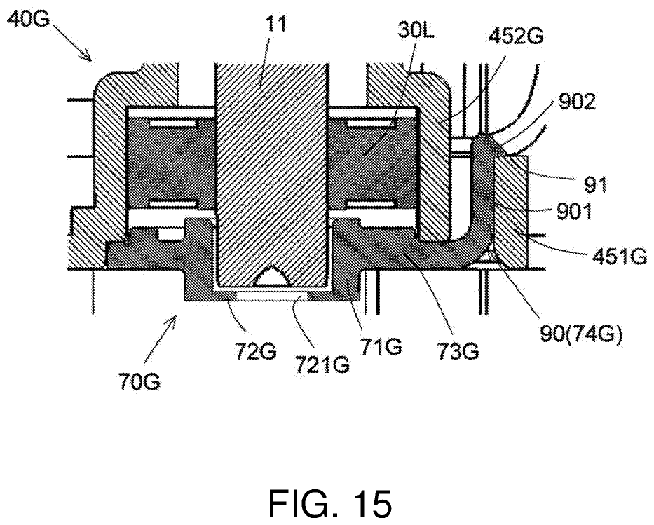

FIG. 15 is an outline vertical sectional view for explaining a seventh modification example of the motor 1 according to the embodiment of the disclosure. FIG. 15 is a vertical sectional view illustrating a structure in the surroundings of a sealing member 70G. Similarly to the aforementioned embodiment, a motor housing 40G has a lower annular part 451G and a first lower tubular part 452G. The lower bearing 30L is disposed at the first lower tubular part 452G. The sealing member 70G has a tubular part 71G, a cover part 72G, and a base part 73G.

The tubular part 71G extends in the axial direction and has an inner surface in the radial direction that faces the outer surface of the shaft 11 in the radial direction with a gap interposed therebetween in the radial direction. The cover part 72G extends inward in the radial direction from an inner surface of the tubular part 71G in the radial direction at a lower end of the tubular part 71G. However, the cover part 72G may extend in the radial direction from the inner surface in the radial direction at a position below the upper end of the tubular part 71G and above the lower end thereof. An upper surface of the cover part 72G faces the lower surface of the shaft 11 with a gap interposed therebetween in the axial direction. The cover part 72G has a through-hole 721G penetrating therethrough in the axial direction on an inner side in the radial direction from the outer end of the shaft 11 in the radial direction. The base part 73G spreads outward in the radial direction from a position below the upper end of the tubular part 71G and above the lower end thereof. However, the base part 73G may spread outward in the radial direction from the upper end or the lower end of the tubular part 71G.

One of the sealing member 70G and the motor housing 40G has a latching part 90 with elasticity. The other one of the sealing member 70G and the motor housing 40G has a latched part 91 to which the latching part 90 is secured. In this manner, it is possible to easily secure the sealing member 70G and the motor housing 40G to each other using snap fitting, for example.

In the modification example, the sealing member 70G has the latching part 90. The motor housing 40G has the latched part 91. The latching part 90 extends in the axial direction in an outer surface of the base part 73G in the radial direction. The latching part 90 also serves as the connection part 74G that is connected to the motor housing 40G. The latching part 90 has an elastic plate-shaped part 901 and a claw part 902. The elastic plate-shaped part 901 is connected to an outer end of the base part 73G in the radial direction such that the elastic plate-shaped part 901 can be elastically deformed. The claw part 902 is disposed at an upper end of the elastic plate-shaped part 901. The latched part 91 is an upper surface of the lower annular part 451G. The sealing member 70G is secured to the lower annular part 451G by the claw part 902 being hooked at the upper surface of the lower annular part 451G. In addition, although one latching part 90 may be provided, a plurality of latching parts 90 is preferably provided at intervals in the circumferential direction.

In a case in which the sealing member 70G is configured not to have the base part 73G, the latching part 90 may be provided at the tubular part 71G. In this case, the outer surface of the tubular part 71G in the radial direction may come into contact with the inner surface of the first lower tubular part 452G in the radial direction, and the latching part 90 may be secured to the upper surface of the lower annular part 451G that functions as the latched part 91, for example. In a case of such a configuration, it is possible to appropriately keep the gap between the sealing member 70G and the shaft 11 as compared with a case in which the sealing member 70G is secured to the motor housing 40G through screwing or the like performed on the tubular part 71G.

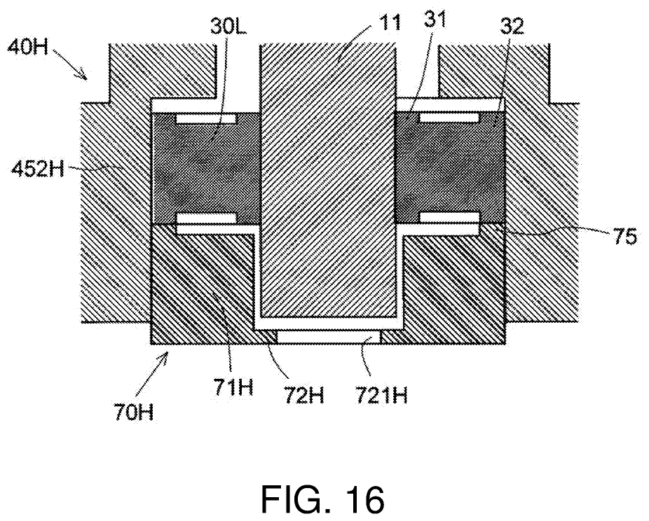

FIG. 16 is an outline vertical sectional view for explaining an eighth modification example of the motor 1 according to the embodiment of the disclosure. FIG. 16 is a vertical sectional view illustrating a structure in the surroundings of a sealing member 70H. Similarly to the aforementioned embodiment, a motor housing 40H has a first lower tubular part 452H at which the lower bearing 30L is disposed.

The sealing member 70H has a tubular part 71H and a cover part 72H. The tubular part 71H extends in the axial direction and has an inner surface in the radial direction that faces the outer surface of the shaft 11 in the radial direction with a gap interposed therebetween in the radial direction. The tubular part 71H is connected directly or indirectly to an inner surface of the first lower tubular part 452H in the radial direction and is secured to the first lower tubular part 452H. The cover part 72H extends inward in the radial direction from an inner surface of the tubular part 71H in the radial direction at a lower end of the tubular part 71H. However, the cover part 72H may extend in the radial direction from the inner surface in the radial direction at a position below the upper end of the tubular part 71H and above the lower end thereof. An upper surface of the cover part 72H faces the lower surface of the shaft 11 with a gap interposed therebetween in the axial direction. The cover part 72H has a through-hole 721H penetrating therethrough in the axial direction on an inner side in the radial direction from the outer end of the shaft 11 in the radial direction.

In addition, the sealing member 70H may have at least a portion corresponding to the base part 73 of portions corresponding to the aforementioned base part 73 and the connection part 74.

In the modification example, the sealing member 70H has elasticity. An upper surface of the sealing member 70H supports the lower surface of the outer ring 32 of the lower bearing 30L. The lower bearing 30L is a rolling bearing. That is, the upper surface of the sealing member 70H supports the lower surface of the outer ring 32 of the rolling bearing 30L. The upper surface of the sealing member 70H preferably does not come into contact with a portion inside the outer ring 32 of the lower bearing 30L in the radial direction. Therefore, a projection 75 that projects upward is provided on the upper surface of the tubular part 71H, and the projection 75 comes into contact with the outer ring 32 in the modification example. Also, the projection 75 has an annular shape around the central axis C at the center. A plurality of projections 75 may be aligned at intervals in the circumferential direction.

According to the modification example, it is possible to apply a preload in the axial direction to the outer ring 32 of the lower bearing 30L with the sealing member 70H and to curb generation of vibration and noise at the time of driving of the motor 1. Also, according to the modification example, it is not necessary to dispose the elastic member 80 between the sealing member 70H and the lower bearing 30L in the axial direction, and it is thus possible to reduce the number of components in the motor 1.

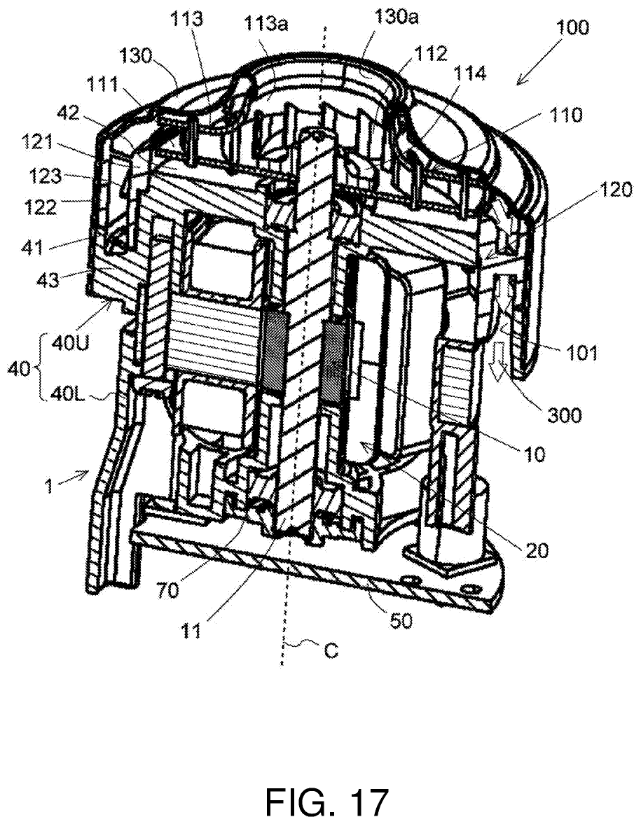

Next, an embodiment of the blowing device 100 to which the motor 1 according to the embodiment is applied will be described. FIG. 17 is a perspective view illustrating a vertical section of the blowing device 100 according to the embodiment of the disclosure. The blowing device 100 includes the motor 1 with the aforementioned configuration and an impeller 110. The blowing device 100 further includes a diffuser 120 and an impeller cover 130.

The impeller 110 is disposed above the motor 1 and is secured to the shaft 11. The impeller 110 rotates along with the rotor 10. The impeller 110 rotates about the central axis C. The impeller 110 is made of a metal member, for example. An outer edge of the impeller 110 in the radial direction has a circular shape in a plan view in the axial direction. The impeller 110 has a base plate 111, a plurality of blades 112, a shroud 113, and a hub 114.

The base plate 111 is disposed below the impeller 110. The base plate 111 spreads in the radial direction around the central axis C at the center. The base plate 111 is a circular plate-shaped member. The base plate 111 supports lower parts of the blades 112.

The plurality of blades 112 is disposed above the base plate 111. The plurality of blades 112 is aligned in the circumferential direction in an upper surface of the base plate 111. The respective lower parts of the plurality of blades 112 are connected to the base plate 111. The respective upper parts of the plurality of blades 112 are connected to the shroud 113. The blades 112 are plate-shaped members standing in the upward-downward direction. The blades 112 extend outward in the radial direction from the inside in the radial direction and are bent in the circumferential direction.

The shroud 113 is disposed above the plurality of blades 112. The shroud 113 has an inner end in the radial direction and an outer end in the radial direction, which have annular shapes around the center axis C at the center, respectively, in a plan view in the axial direction. The shroud 113 is made of an annular plate-shaped member, and specifically, the shroud 113 is bent upward from the outer end in the radial direction toward the inside in the radial direction. The shroud 113 has a shroud air intake port 113a that is opened on the upper and lower sides. The shroud air intake port 113a is disposed at the center of the shroud 113. The shroud 113 supports the upper parts of the blades 112.

The hub 114 is disposed near the central axis C of the base plate 111 and at the center of the base plate 111. The hub 114 has an annular shape in a plan view in the axial direction. The shaft 11 penetrates through the hub 114 in the upward-downward direction along the central axis C at the center of the hub 114 and is secured to the hub 114. That is, the impeller 110 is secured to the shaft 11.

The diffuser 120 has a first diffuser tubular part 121, a second diffuser tubular part 122, and a plurality of vanes 123. In the embodiment, the first diffuser tubular part 121, the second diffuser tubular part 122, and the plurality of vanes 123 are a single member. However, at least any one of these members may be a separate member.

The first diffuser tubular part 121 is disposed outward from the second housing part 42 in the radial direction. The first diffuser tubular part 121 has a tubular shape extending in the axial direction around the central axis C at the center. In the radial direction, an inner surface of the first diffuser tubular part 121 in the radial direction comes into contact with an outer surface of the second housing part 42 in the radial direction.

The second diffuser tubular part 122 is disposed outward from the first diffuser tubular part 121 in the radial direction. The second diffuser tubular part 122 has a tubular shape extending in the axial direction around the central axis C at the center. The second diffuser tubular part 122 is disposed above the first housing part 41. A lower surface of the second diffuser tubular part 122 comes into contact with the upper surface of the first housing part 41 in the axial direction.

In addition, the positions of the upper surface of the first diffuser tubular part 121 and the upper surface of the second diffuser tubular part 122 in the axial direction are same. The length of the first diffuser tubular part 121 in the axial direction is longer than that of the second diffuser tubular part 122. A lower end of the first diffuser tubular part 121 is disposed below a lower end of the second diffuser tubular part 122.

The plurality of vanes 123 is aligned in the circumferential direction between the first diffuser tubular part 121 and the second diffuser tubular part 122 in the radial direction. Specifically, the plurality of vanes 123 is aligned at equal intervals in the circumferential direction. The respective vanes 123 extend in the axial direction. Inner surfaces of the respective vanes 123 in the radial direction are connected to an outer surface of the first diffuser tubular part 121 in the radial direction. Outer surfaces of the respective vanes 123 in the radial direction are connected to an inner surface of the second diffuser tubular part 122 in the radial direction. A portion where the plurality of vanes 123 is not provided between the first diffuser tubular part 121 and the second diffuser tubular part 122 in the radial direction forms a flow path 101 through which air flows. The plurality of vanes 123 rectifies the air flow 300 that passes through the flow path 101.

The impeller cover 130 is disposed above the impeller 110. The impeller cover 130 accommodates the impeller 110 therein. The impeller cover 130 has a tubular shape that becomes thinner toward the upper side around the central axis C at the center. An inner surface of the impeller cover 130 in the radial direction comes into contact with outer surfaces of the second diffuser tubular part 122 and the first housing part 41 in the radial direction. The impeller cover 130 is secured to the second diffuser tubular part 122 and the upper housing 40U.

The impeller cover 130 has a cover air intake port 130a that is opened on the upper and lower sides. The cover air intake port 130a is disposed at an upper end and the center of the impeller cover 130. A lower part of the cover air intake port 130a overlaps with an upper part of the shroud air intake port 113a in the axial direction. An outer diameter of the lower part of the cover air intake port 130a is smaller than an inner diameter of the upper part of the shroud air intake port 113a.

If the impeller 110 is driven and rotated by the motor 1, the air flow 300 of air suctioned from the cover air intake port 130a of the impeller cover 130 into the impeller 110 is generated. The air suctioned into the impeller 110 is blown out of the impeller 110 in the radial direction with the rotation of the impeller 110. The air blown out of the impeller 110 in the radial direction passes through the flow path 101 formed of the impeller cover 130, the diffuser 120, and the upper housing 40U and is guided downward. A part of the air flow 300 blown downward out of the lower end of the upper housing 40U flows out of the blowing device 100, and another part thereof flows into the motor housing 40 and toward the circuit substrate 50. The stator 20, the circuit substrate 50, and the like are cooled with the air flow 300.

Also, the ribs 43 may include rib through-holes formed so as to penetrate therethrough in the axial direction. In this manner, it is possible to allow the air to flow downward even at a location where the ribs 43 are disposed and to reduce a blowing resistance.

In the embodiment, there is a probability that dust enters the lower bearing 30L due to influences of an air flow flowing toward the inside and the like of the motor housing 40.

However, since the sealing member 70 with excellent dust-proofing properties is disposed at the motor 1 that the blowing device 100 has, it is possible to curb entrance of dust to the lower bearing 30L. In addition, since it is not necessary to use an expensive bearing with dust-proofing sealing, it is possible to manufacture the blowing device 100 at low cost according to the embodiment. Also, since the sealing member 70 has the through-hole 721, it is possible to support the shaft 11 with a jig from the side below the motor 1 and to easily perform an operation of pressure-fitting the impeller 110 to the shaft 11 according to the embodiment.

Next, an embodiment of a vacuum cleaner 200 to which the blowing device 100 according to the embodiment is applied will be described. FIG. 18 is a perspective view of the vacuum cleaner 200 according to the embodiment of the disclosure. As illustrated in FIG. 18, the vacuum cleaner 200 has the blowing device 100. The vacuum cleaner 200 is a so-called stick-type electric vacuum cleaner. In addition, the vacuum cleaner 200 that has the blowing device 100 may be an electric vacuum cleaner of another type, such as a so-called robot type, a canister type, or a handy type.

The vacuum cleaner 200 has a case body 201 with an air intake part 202 and an air discharge part 203 provided in a lower surface and an upper surface thereof. The vacuum cleaner 200 has a rechargeable battery (not illustrated) and operates using power supplied from the battery. However, the vacuum cleaner 200 may have a power supply cord and operate with power supplied via the power supply cord connected to a power supply plug provided in a wall surface of a living room.

An air path (not illustrated) that couples the air intake part 202 and the air discharge part 203 is formed inside the case body 201. A dust collecting part (not illustrated), a filter (not illustrated), and the blowing device 100 are disposed in this order in the air path from the air intake part 202 (upstream) toward the air discharge part 203 (downstream). Wastes such as dust included in the air flowing through the air path are captured by the filter and are collected in the dust collecting part formed into a container shape. The dust collecting part and the filter are provided so as to be able to be attached to and detached from the case body 201.

A gripping part 204 and an operation part 205 are provided at an upper part of the case body 201. A user can grip the gripping part 204 and cause the vacuum cleaner 200 to move. The operation part 205 has a plurality of buttons 205a. The user performs operation setting of the vacuum cleaner 200 through operations of the buttons 205a. For example, commands for starting driving of the blowing device 100, stopping the driving thereof, changing a rotation frequency thereof, and the like are provided through operations of the buttons 205a. A bar-shaped suctioning pipe 206 is connected to the air intake part 202. A suctioning nozzle 207 is attached to an upstream end of the suctioning pipe 206 so as to be able to be attached to and detached from the suctioning pipe 206. In addition, the upstream end of the suctioning pipe 206 is a lower end of the suctioning pipe 206 in FIG. 18.

Since the sealing member 70 with excellent dust-proofing properties is disposed at the motor 1 that the vacuum cleaner 200 has, dust is unlikely to enter the lower bearing 30L, and it is possible to improve durability of the vacuum cleaner 200 according to the embodiment. Also, since it is not necessary to use an expensive bearing with a dust-proofing sealing, it is possible to manufacture the vacuum cleaner 200 at low cost according to the embodiment.

Various technical features disclosed in the specification can be modified in various manners without departing from the gist of the technical ideas. Also, the plurality of embodiments and modification examples described in the specification may be performed in an available combination.

The disclosure can be used for a motor, a blowing device that has a motor, and a vacuum cleaner that has a blowing device, for example.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor comprising:
a rotor that has a shaft disposed along a central axis extending in an upward-downward direction;
a stator that faces the rotor in a radial direction;
a bearing that supports the rotor with respect to the stator such that the rotor is able to rotate about the central axis;
a motor housing that surrounds at least a part of the stator; and
a sealing member that is disposed below the bearing and is secured to the motor housing,
wherein the sealing member includes
a tubular part that extends in an axial direction and has an inner surface in the radial direction that faces an outer surface of the shaft in the radial direction with a gap interposed therebetween in the radial direction, and
a cover part that extends inward in the radial direction from the inner surface of the tubular part in the radial direction and has an upper surface facing a lower surface of the shaft with a gap interposed therebetween in the axial direction, and
the cover part has a through-hole that penetrates therethrough in the axial direction on an inner side in the radial direction from an outer end of the shaft in the radial direction.

2. The motor according to claim 1, wherein the sealing member further includes a base part that spreads outward in the radial direction from an outer surface of the tubular part in the radial direction.

3. The motor according to claim 2, wherein the sealing member further includes a connection part that extends in the axial direction in an outer surface of the base part in the radial direction and is connected to the motor housing.

4. The motor according to claim 1, wherein an outer surface of the tubular part in the radial direction is connected and secured to the motor housing.

5. The motor according to claim 1,
wherein one of the sealing member and the motor housing has a latching part with elasticity, and
the other one of the sealing member and the motor housing has a latched part to which the latching part is secured.

6. The motor according to claim 1, wherein a recessed part that is recessed upward in the axial direction is formed in the lower surface of the shaft.

7. The motor according to claim 1,
wherein the bearing is a rolling bearing,
the sealing member has elasticity, and
an upper surface of the sealing member supports a lower surface of an outer ring of the rolling bearing.

8. The motor according to claim 1,
wherein the bearing is a rolling bearing,
the motor further includes an elastic member that is disposed between the sealing member and the rolling bearing in the axial direction, and
an upper surface of the sealing member supports a lower surface of an outer ring of the rolling bearing via the elastic member.

9. A blower comprising:
the motor according to claim 1; and
an impeller that is disposed above the motor and is secured to the shaft.

10. A vacuum cleaner comprising:
the blower according to claim 9.
